(19) United States
(12) Patent Application Publication
(10) Pub. No.: US 2008/0220283 A1
(43) Pub. Date: Sep. 11, 2008

(54) SUBSTITUTED POLYACETYLENE, COMPLEX AND DEVICE STRUCTURE

(75) Inventors: Takeyuki Sone, Tokyo (JP); Akira Kuriyama, Atsugi-shi (JP); Otto Albrecht, Atsugi-shi (JP); Koji Yano, Cambridge (GB)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/041,513

(22) Filed: Mar. 3, 2008

(30) Foreign Application Priority Data
Mar. 9, 2007 (JP) 2007-060937

(51) Int. Cl. B32B 15/08; C08F 138/02

(52) U.S. Cl. 428/689; 526/285

(57) ABSTRACT

A substituted polyacetylene having an organic functional group bondable to the surface of a metal, a metal oxide or an alloy at least one of the polymer terminals, and a device structure having the substituted polyacetylene and two or more independent electrodes. A helical substituted polyacetylene having a helical structure with a periodic main chain. The organic functional group is at least one selected from the group consisting of a thiol group, a sulfide group, a disulfide group, a thioacetyl group, an isocyanide group, a carboxylic acid group and a phosphoric acid group.

### BACKGROUND OF THE INVENTION

1. Field of the Invention

The present invention relates to a substituted polyacetylene capable of bonding to the surface of a metal or the like, a complex of a metal or the like and a substituted polyacetylene, and a device structure.

2. Description of the Related Art

Polyacetylene has alternating double bonds, and is well known as the simplest π (pi) conjugated system polymer. Above all, a substituted polyacetylene receives attention as a π conjugated system polymer which is, unlike a unsubstituted polyacetylene, soluble and stable even in air, while having a main chain skeleton similar to that of the unsubstituted polyacetylene. In particular, it is known that a mono-substituted polyacetylene is subjected to stereoregular polymerization by use of a rhodium complex catalyst and that the resultant polymer has a high structural regularity as compared with a polymer polymerized using a conventional metathesis catalyst.

This mono-substituted polyacetylene has a head-to-tail bond and stereoregularity of cis-transoid geometry, and its main chain has a helical structure, so that this mono-substituted polyacetylene receives attention as a chiral polymer. The rhodium complex catalyst has high polymerization activity with respect to a mono-substituted acetylene having various functional groups such as a polar functional group and a radical containing functional group. Therefore, the catalyst is expected to be a conductive material which has only little restriction on a side chain structure and whose molecules can freely be designed.

However, in the present circumstances, in a case where an electronic device using organic molecules including polyacetylene is joined to electrodes, the joint usually depends only on physical contact. Stronger electric joining is a large theme. To solve the problem, a technology is required in which the organic molecules are not only brought into physical contact with the electrodes but also chemically bonded to the electrodes, whereby the organic molecules are more firmly joined to the electrodes. As such a technology, a system using gold-thiol bond is reported.

For example, U.S. Pat. No. 5,475,341 and U.S. Pat. No. 5,589,692 discuss a method in which thiol is introduced into a terminal of oligo thiophene, and bonded to a metal electrode. However, the molecules have a length less than 10 nm, and it is difficult to put the method to practical use in a device using an electrode structure.

Moreover, examples of a method for introducing an organic functional group into a polymer terminal of polyacetylene include a terminal modification method making use of living polymerization. For example, Japanese Patent Application Laid-Open No. 2001-318906 discusses acetylene polymerization method using a titanium compound as an example of a method for introducing a polymer terminal into polyacetylene. It is disclosed that in this method, the polymer terminal can be controlled and that alkyl, aralkyl and aryl groups can be introduced.

Furthermore, examples of a method for modifying the polymer terminal of a substituted polyacetylene include a method disclosed in M. Miyake, Y. Misumi and T. Masuda, Macromolecules, 33, p. 6636 to 6639 (2000). This non-patent document discusses that a triphenyl vinyl group and a derivative of the group can be introduced into the polymer terminal on one side in synthesis of a mono-substituted polyacetylene making use of the rhodium complex catalyst.

### SUMMARY OF THE INVENTION

The present invention has been developed in view of such background technology, and an object of the present invention is to provide a substituted polyacetylene in which an organic functional group having a bond property to a solid surface, especially a conductive surface of a metal, a metal oxide or an alloy is introduced into a polymer terminal of polyacetylene to improve an adhering bond property to the conductive surface.

Another object of the present invention is to provide a device structure in which a pair of electrodes is installed via the substituted polyacetylene to bridge the electrodes with each other by use of one substituted polyacetylene molecule to achieve a high operation speed.

A further object of the present invention is to provide a complex of a metal or the like and a substituted polyacetylene.

The substituted polyacetylene to solve the above problem is characterized by having a substituted or unsubstituted polyacetylene having an organic functional group capable of bonding to the surface of a metal, a metal oxide or an alloy at least one of the polymer terminals.

The substituted polyacetylene is preferably a helical substituted polyacetylene having a helical structure with a periodic main chain.

The organic functional group is preferably at least one selected from the group consisting of a thiol group, a sulfide group, a disulfide group, a thioacetyl group, an isocyanide group, a carboxylic acid group and a phosphoric acid group.

A device structure to solve the above problem is characterized by having the substituted polyacetylene and two or more independent electrodes.

Moreover, the present invention is directed to a complex characterized by having a metallic material selected from the group consisting of a metal, a metal oxide and an alloy, and a terminal-functionalized polyacetylene, wherein the terminal-functionalized polyacetylene has a polymer chain terminal bonded to the metallic material.

The polymer chain terminal is a substituent at a terminal which is not included in a polymer chain repeated structure, and represented by Ex, Ey of Formula 1 described later. The terminal-functionalized polyacetylene means a polyacetylene in which an arbitrary substituent is introduced into the polymer chain terminal.

The terminal-functionalized polyacetylene is preferably a helical substituted polyacetylene having a helical structure with a periodic main chain.

Moreover, the present invention is directed to a device which is characterized by comprising electrodes formed of a metallic material selected from the group consisting of a metal, a metal oxide and an alloy, and a terminal-functionalized polyacetylene, wherein the terminal-functionalized polyacetylene has a polymer chain terminal bonded to the electrodes.

The substituted polyacetylene according to the present invention has a satisfactory bond property between the polymer terminal and the conductive surface. The conductive surface is coated with this polyacetylene, and a pair of electrodes is installed via the polymer chain, whereby an organic device structure can be realized in which the pair of opposing electrodes are bridged with one molecule to achieve a high operation speed.

Moreover, according to the substituted polyacetylene of the present invention, the insulating coating can be performed with a side chain substituent, whereby hopping between the molecules is inhibited, and a carrier can move at a high speed.

Furthermore, the present invention can provide a complex formed of a metal or the like and the substituted polyacetylene.

Further features of the present invention will become apparent from the following description of exemplary embodiments with reference to the attached drawings.

### BRIEF DESCRIPTION OF THE DRAWINGS

FIG. 1 is a schematic diagram showing one embodiment of a structure in which a substituted polyacetylene is formed on a substrate according to the present invention.

FIG. 2 is a schematic diagram showing another embodiment of the structure in which the substituted polyacetylene is formed on the substrate according to the present invention.

FIG. 3 is a schematic diagram showing a metal pattern electrode substrate.

FIG. 4 is a schematic diagram showing one embodiment of a device structure according to the present invention.

FIG. 5 is a schematic diagram showing another embodiment of the device structure according to the present invention.

FIG. 6 is a schematic diagram showing still another embodiment of the device structure according to the present invention.

FIG. 7 is a schematic diagram showing a further embodiment of the device structure according to the present invention.

### DESCRIPTION OF THE EMBODIMENTS

The present invention will hereinafter be described in detail.

A substituted polyacetylene of the present invention is characterized in that it has a substituted or unsubstituted polyacetylene having an organic functional group capable of bonding to the surface of a metal, a metal oxide or an alloy (referred to also as the metal or the like) at least one of the polymer terminals.

Polyacetylene has long been investigated as the simplest conjugated polymer in both an experiment field and a theoretical field. A polyacetylene film is most investigated in the experiment field, and a polymer forms a crystal structure in the film. This polyacetylene film is doped with iodine, and a large amount of holes are formed in the molecule to exhibit a remarkably high conductivity. Movement of a carrier in the film can be divided into movement in the molecule and movement between the molecules. The carrier moves in the molecule at a remarkably high speed, but hopping movement between the molecules controls the speed of the carrier movement. Therefore, if the device is prepared using only one molecule, the carrier movement at a very high speed can supposedly be realized, but is not realized in the present circumstances. The terminal of polyacetylene of the present invention bonds to the conductive surface, so that electrodes can be provided to the opposite ends of one molecule, and a device using one molecule of polyacetylene can be realized.

Moreover, the substituted polyacetylene of the present invention has stereoregularity, and the main chain forms a helical structure. The helical structure of the main chain is surrounded with side chains. Therefore, an insulating substituent such as an alkyl group is introduced into the side chain terminal, whereby a conductive wire of one molecule coated with an insulating layer can be prepared. Such a molecular wire coated with the insulating layer is used, whereby hopping of the carrier between the molecule chains can be inhibited. Therefore, a high speed and high efficiency device having a shorter channel length can be provided.

Furthermore, the substituted polyacetylene receives attention as a helical polymer having a main chain with a regularly periodic structure. It is known that chirality can be imparted to the side chain of the substituted polyacetylene to form a one-direction helix-rich structure. The substituted polyacetylene having such a chiral helix structure has a chiral resolution ability to resolve, for example, an L-form and a D-form, and application thereof to medicine manufacturing can be expected. When the substituted polyacetylene is used in a chiral resolution by column chromatography, it is a theme to strongly bond the substituted polyacetylene to carriers such as holding particles in a column. The substituted polyacetylene of the present invention has a bond property to the solid surface of a metal or the like, and hence there is an advantage that the substituted polyacetylene can easily be bonded to carriers such as particles.

There is not any special restriction on the structure of the substituted polyacetylene, but examples of the structure include structures represented by the following Formulas 1 and 2.

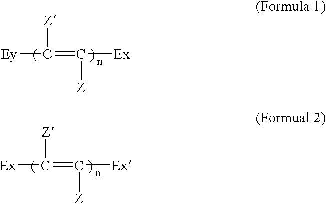

In the formulas, Z represents a substituent group having a hetero atom or a metal atom, in addition to a chain or cyclic hydrocarbon group. Specific examples of the Z include a phenyl group, a methyl phenyl group, a methoxy phenyl group, an ethyl ester group, a methyl group and a cyclohexyl group. Z′ may be a substituent similar to Z or a hydrogen atom.

In the formulas, Ex and Ex′ represent organic functional groups capable of bonding to the surface of a metal, a metal oxide or an alloy, and are bonded to the polymer terminals of polyacetylene. In the present invention, the polymer terminals mean bonding positions of Ex and Ex′ in Formula 1. The organic functional group means a substituent group bonded to a terminal of the polymer which cannot be described in the repeated structure within the parentheses.

Specific examples of Ex and Ex′ include a thiol group (a), a sulfide group (b), a dithiol group (c) and a thioacetyl group (d) represented by the following formula 3 as functional groups having a satisfactory bond property to, for example, gold. Examples of a functional group having a satisfactory bond property to gold and platinum include an isocyanide group (e), and examples of a functional group having a satisfactory bond property to ITO include a carboxylic acid group (f) and a phosphoric acid group (g). Here, R is a substituted or unsubstituted hydrocarbon group.

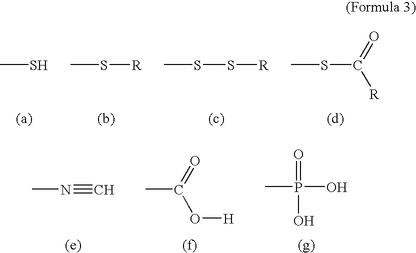

In Formula 1, Ey is a substituent which does not have a bond property to the surface of the metal, the metal oxide or the alloy. Examples of the substituent which does not have any bond property to the surface of gold include an alkyl group which does not contain any hetero atom.

In Formulas 1 and 2, n is an integer of 1 or more.

Polyacetylene in which only the polymer terminal on one-side is modified with the organic functional group as in Formula 1 is used, whereby the only one-side polymer terminal can bond to the solid surface of the metal or the like to easily cover the solid surface.

Moreover, polyacetylene in which the polymer terminals on its both sides are modified with the organic functional groups as in Formula 2 is used, whereby the polymer terminals on the both sides function as terminals connected to electrodes, and the polyacetylene molecules can be joined to a plurality of opposing electrodes. In the polyacetylene represented by Formula 2, Ex and Ex′ may be the same substituent or different substituents.

There is not any special restriction on a process of modifying the terminal with the organic functional group, but the modification can be achieved, for example, by beforehand introducing a functional group capable of bonding to a specific solid surface into a ligand of a mononuclear rhodium complex as a living polymerization catalyst. For example, it is disclosed that a rhodium complex represented by the following Formula 4 can be used as a polymerization catalyst for a substituted acetylene, thereby modifying the triphenyl vinyl group moiety as the polymer terminal. Furthermore, by using, instead of the above complex, for example, a rhodium complex represented by Formula 5 as the polymerization catalyst for the substituted acetylene, the polymer terminal can be modified with a 1-phenyl(2,2-bis(p-mercaptophenyl))vinyl group, and as a result, the substituted polyacetylene in which the thiol group is introduced into the polymer terminal can be prepared. Moreover, by use of, for example, a rhodium complex represented by Formula 6 as the polymerization catalyst for the substituted acetylene, a 1-phenyl(2,2-bis((p-(1-mercapto-n-butyl))phenyl))vinyl group in which a spacer is disposed between the thiol group and the phenyl group can be introduced into the polymer terminal. Not only the thiol group but also a rhodium complex in which carboxyl groups are introduced as shown by Formula 7 may be used as the polymerization catalyst.

As polymerization solvents, a non-polar solvent such as chloroform, tetrahydrofuran or toluene, or a polar solvent such as dimethylformamide may be used. These solvents may be used alone or as a mixture.

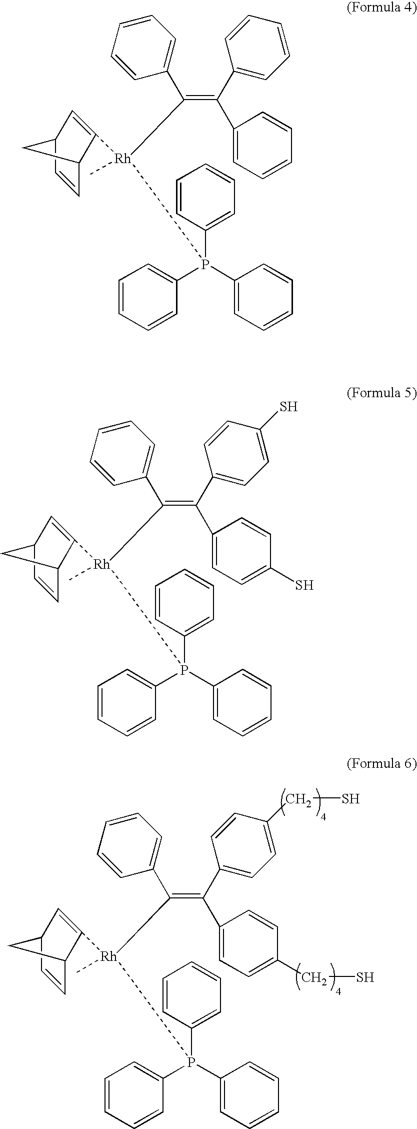

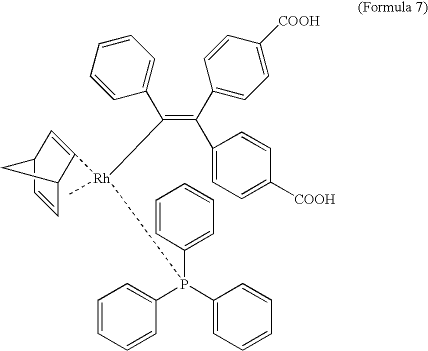

Moreover, to form a structure in which the substituted polyacetylene having the organic functional groups at the polymer terminal is coated on a base having the surface of the metal or the like having a bond property to the organic functional group, the polyacetylene may be polymerized, and then mixed with the base. Alternatively, the base such as the metal or the like may be mixed with and bonded to the catalyst, followed by adding an acetylene monomer thereto to grow a polymer of the substituted polyacetylene from the surface of the metal or the like.

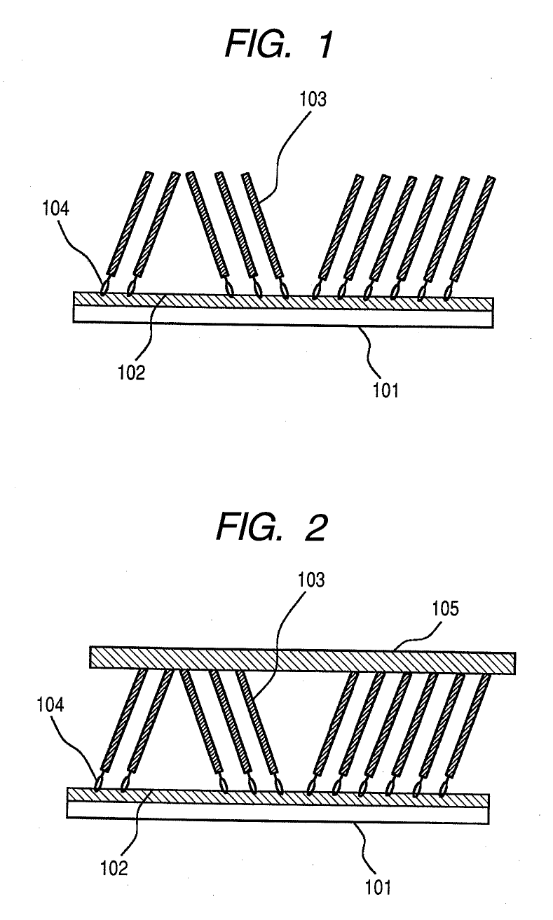

For example, the substituted acetylene is polymerized by use of the rhodium complex having the functional group having the bond property to gold, for example, the thiol group, and the resultant substituted polyacetylene having the modified polymer terminal is dissolved in a good solvent such as toluene, followed by immersing therein the base having the gold surface, for example, a mica substrate having one surface on which gold has been vapor deposited. In consequence, gold bonds to the thiol group, and a film-like structure is obtained in which a substituted polyacetylene 103 is integrated on the surface of a substrate 101 as shown in FIG. 1.

Moreover, the rhodium complex having the functional group having the bond property to gold, for example, the thiol group is dissolved in a good solvent such as toluene, and the base having the gold surface, for example, the mica substrate having one surface on which gold has been vapor deposited is immersed in the solution, whereby gold bonds to the thiol group to obtain a substrate having the surface thereof on which the rhodium complexes have been integrated. This substrate is immersed in a good solvent solution for a substituted acetylene, for example, a toluene solution, whereby polymerization proceeds to obtain a structure in which the substituted polyacetylene has grown on the substrate as shown in FIG. 1.

Such a structure can be used as an electronic device. For example, when a thin gold film 105 is formed from above the structure shown in FIG. 1 by vacuum evaporation, a device having a structure shown in FIG. 2 is obtained. This device has a sandwich structure in which polyacetylene is held between upper and lower electrodes, and polyacetylene molecules each are joined to the upper and lower electrodes. Therefore, in the device, hopping between molecule chains is not caused.

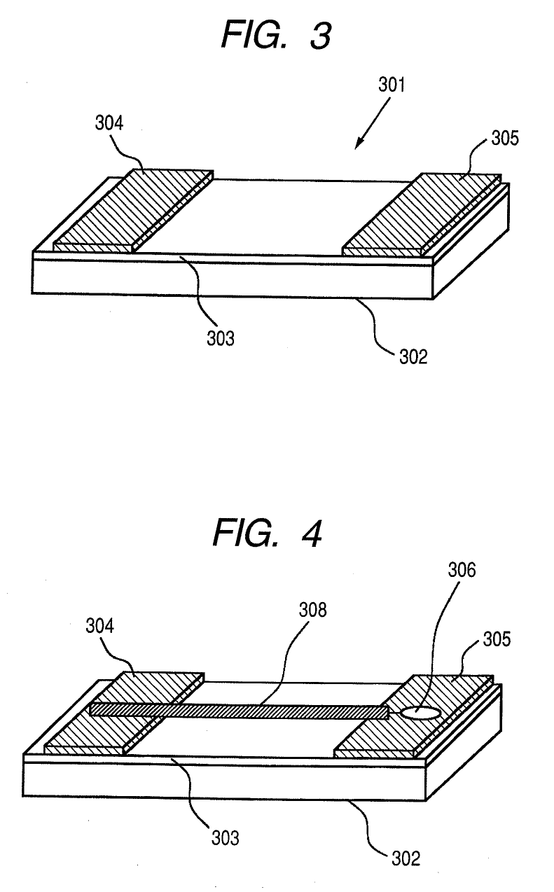

A solution of the substituted polyacetylene having the modified polymer terminal on one side as represented by Formula 1 is prepared by the above-mentioned method, and a metal pattern electrode substrate 301 shown in FIG. 3 is immersed in the solution, whereby a metal electrode 305 bonds to an organic functional group 306 at the polymer terminal to obtain an electrode structure shown in FIG. 4 at a certain probability. A substrate treatment or an orientation treatment with an external force is performed to further increase the probability. In this electrode structure, the organic functional group 306 of the polymer terminal bonds to the metal electrode 305, and polyacetylene molecules 308 electrostatically come in contact with a metal electrode 304 as a counter-electrode.

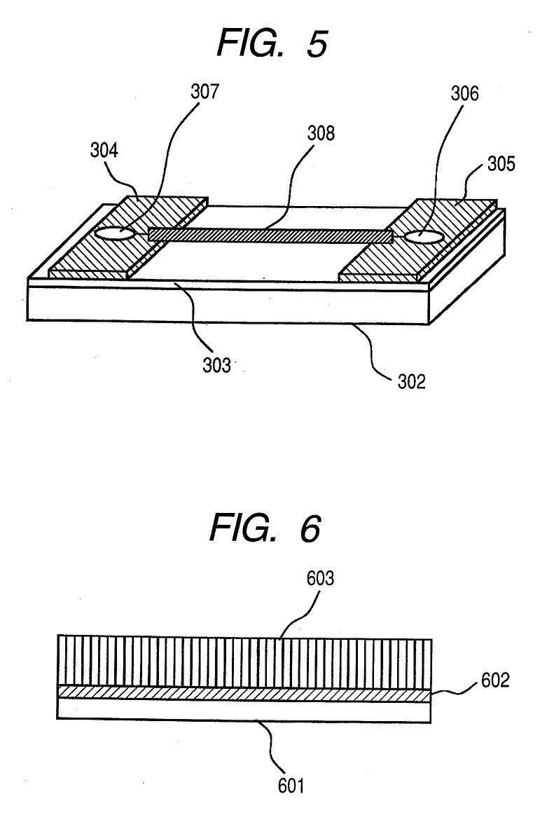

Moreover, a solution of polyacetylene having the modified polymer terminals on the both sides as represented by Formula 2 is prepared by the above-mentioned method, and the metal pattern electrode substrate shown in FIG. 3 is immersed in the solution, whereby the metal electrodes bond to the polymer terminals to obtain a device structure shown in FIG. 5 stochastically. In this electrode structure, an organic functional group 306 at the polymer terminal bonds to a metal electrode 305, and an organic functional group 307 at the other polymer terminal also bonds to a metal electrode 304 as a counter-electrode.

### EXAMPLES

A method for producing the substituted polyacetylene of the present invention and a method for fabricating a structure in which metal electrodes are coated with the substituted polyacetylene will hereinafter be described.

Examples of polyphenylacetylene in which a thiol group is introduced into the terminal, and examples of a device structure in which the resultant polyphenylacetylene is used will be described.

### Example 1

### Preparation Method for Rhodium Complex Catalyst Containing Thiol Group

In a test tube which is subjected to pressure reduction and nitrogen replacement and then tightly sealed, 0.1 mol of triphenylphosphine and 0.01 mol of a dimmer of rhodium (norbornadiene) chloride are placed, and 5 mL of toluene is added as a solvent thereto to keep the solution at 0° C. Afterward, 5 mL of a toluene solution of 1,1′-bis(p-mercaptophenyl)-2-phenylvinyl lithium with a concentration of 8×10⁻³ mols/L is added and the resultant is stirred at 0° C. for one (1) hour to obtain a [rhodium(norbornadiene)(bis(1,1′-dimercaptophenyl-2-phenylvinyl)(triphenylphosphine)] complex represented by Formula 5.

(Synthesis Method for Terminal-Modified Polyacetylene)

10 ml of the rhodium complex solution having a concentration of 1.0×10⁻³ mols/L thus obtained by the above method is placed in an eggplant type flask, and a mixture solution of 0.5 g of phenylacetylene and 15 ml of toluene is poured into the solution to initiate a polymerization reaction. The reaction is performed at 20° C. for two (2) hours, and the resultant polymer is washed with methanol and filtered. Afterward, vacuum drying is performed for 24 hours to obtain polyphenylacetylene in which the polymer terminals are modified with thiol groups.

(Preparation Method for a Structure)

The polymer terminal-modified polyphenylacetylene thus obtained by the above method is dissolved in toluene to prepare a solution of 10⁻³ g/L. A mica substrate having one surface on which gold is evaporated is immersed in this solution, and left to stand for one (1) hour. Afterward, the substrate is washed with toluene and dried, whereby a complex structure is obtained in which the polyacetylene is bonded onto the substrate as shown in FIG. 6.

### Example 2

### Preparation Method for Rhodium Complex Catalyst Containing Carboxyl Group

In a test tube which is subjected to pressure reduction and nitrogen replacement and then tightly sealed, 0.1 mol of triphenylphosphine and 0.01 mol of a dimmer of rhodium (norbornadiene) chloride are placed, and 5 mL of toluene is added as a solvent thereto to keep the solution at 0° C. Afterward, 5 mL of a toluene solution of 1,1′-bis(p-carboxyphenyl)-2-phenylvinyl lithium with a concentration of 8×10⁻³ mols/L is added and the resultant is stirred at 0° C. for one (1) hour to obtain a [rhodium(norbornadiene)(bis(1,1′-dicarboxyphenyl-2-phenylvinyl)(triphenylphosphine)] complex represented by Formula 7.

(Synthesis Method for Terminal-Modified Polyacetylene)

Phenylacetylene is polymerized using the rhodium complex obtained by the above method in the same manner as in Example 1 to obtain polyphenylacetylene having a polymer terminal modified with a carboxyl group.

(Preparation Method for a Structure)

The polymer terminal-modified polyphenylacetylene obtained by the above method is dissolved in toluene to prepare a solution of 10⁻³ g/L. A glass substrate having an ITO layer is immersed in this solution, and left to stand for one (1) hour. Afterward, the substrate is washed with toluene and dried, whereby a complex structure is obtained in which the polyacetylene is bonded onto the substrate as shown in FIG. 6.

### Example 3

### Preparation Method for a Structure

Toluene is added to a solution of the thiol group containing rhodium complex obtained by the method of Example 1 to prepare a solution of 10⁻⁴ g/L. A gold substrate which is prepared, for example, by vacuum-evaporating about 10 nm of gold on one surface of a mica substrate is immersed in this solution, and left to stand for one (1) hour. Afterward, the substrate is washed with toluene, whereby a complex structure is obtained in which the rhodium complex is bonded onto the substrate. A toluene solution of phenylacetylene is added as a monomer to this complex structure, and left to stand for two (2) hours, whereby a film similar to that of FIG. 6 is obtained which is formed of polyacetylene molecules growing on the substrate.

### Example 4

### Preparation Method for a Device Structure

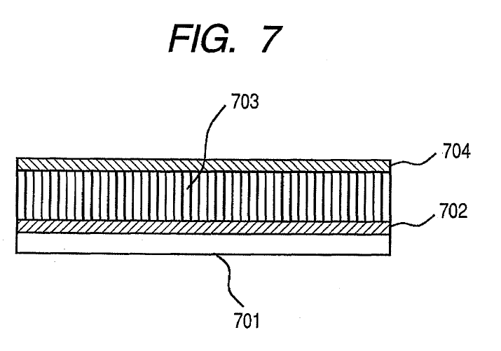

A device according to the present example is formed on a mica substrate 701 having the surface on which a thin gold film 702 having a film thickness of 10 nm is evaporated. A substituted polyacetylene film 703 is formed on this gold substrate by the method of Example 2 or Example 3, and a thin gold film 704 is vacuum-evaporated on the film, whereby a device structure can be prepared in which a substituted polyacetylene is held between two thin gold film electrodes as shown in FIG. 7.

A complex of a metallic material and the substituted polyacetylene according to the present invention has a satisfactory bond property between the polymer terminal and the conductive surface. A pair of electrodes disposed via a polymer chain is installed on the complex in which the surface of the conductive metallic material is coated with polyacetylene to bridge the opposing electrodes with one molecule. In consequence, the complex can be used in an organic device structure having a high operation speed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-060937, filed Mar. 9, 2007, which is hereby incorporated by reference herein in its entirety.

What is claimed is:

1. A substituted polyacetylene comprising a substituted or unsubstituted polyacetylene, wherein the substituted or unsubstituted polyacetylene has an organic functional group capable of bonding to the surface of a metal, a metal oxide or an alloy at least one of the polymer terminals.

2. The substituted polyacetylene according to claim 1, which is a helical substituted polyacetylene having a helical structure with a periodic main chain.

3. The substituted polyacetylene according to claim 1, wherein the organic functional group is at least one selected from the group consisting of a thiol group, a sulfide group, a disulfide group, a thioacetyl group, an isocyanide group, a carboxylic acid group and a phosphoric acid group.

4. A device structure comprising the substituted polyacetylene according to claim 1 and two or more independent electrodes.

5. A complex comprising a metallic material selected from the group consisting of a metal, a metal oxide and an alloy, and a terminal-functionalized polyacetylene, wherein the terminal-functionalized polyacetylene has a polymer chain terminal bonded to the metallic material.

6. The complex according to claim 5, wherein said terminal-functionalized polyacetylene is a helical substituted polyacetylene having a helical structure with a periodic main chain.

7. A device comprising electrodes formed of a metallic material selected from the group consisting of a metal, a metal oxide and an alloy, and a terminal-functionalized polyacetylene, wherein the terminal-functionalized polyacetylene has a polymer chain terminal bonded to the electrodes.
